(19) United States
(12) Patent Application Publication
(10) Pub. No.: US 2016/0056620 A1
(43) Pub. Date: Feb. 25, 2016

(54) MODULAR HOLDER FOR ELECTRIC CONDUCTORS

(71) Applicant: EATON INDUSTRIES (AUSTRIA) GMBH, Schrems (AT)

(72) Inventor: Franz WEIGL, Waldenstein (AT)

(21) Appl. No.: 14/781,912

(22) PCT Filed: Apr. 3, 2014
(86) PCT No.: PCT/EP2014/056645

§ 371 Date: Oct. 2, 2015

(30) Foreign Application Priority Data
Apr. 5, 2013 (DE) 10 2013 103 441.1

(51) Int. Cl. H02G 3/04

(52) U.S. Cl. CPC H02G 3/0437; H02G 3/0406

(57) ABSTRACT

A modular system for holding a number of electric conductors includes an electrically insulating holder with a number of through-holes spaced at a distance from one another for allowing the passage of said electric conductors. in addition, the modular system includes a base plate having a material with better insulating properties than the holder, and has one or more first units for connecting the holder to the base plate.

### CROSS-REFERENCE TO RELATED APPLICATIONS

This application is a U.S. national stage application under 35 U.S.C. §371 of International Application No. PCT/EP2014/056645, filed on Apr. 3, 2014, and claims benefit to German Patent Application No. DE 10 2013 103 441.1, filed on Apr. 5, 2013. The International Application was published in German on Oct. 9, 2014, as WO 2014/161915 A1 under PCT Article 21(2).

### FIELD

The invention relates to a modular system for holding a number of electric conductors, comprising an electrically insulating holder with a number of through-holes spaced at a distance from one another for allowing the passage of said electric conductors.

### BACKGROUND

A modular system, or a holder of the type mentioned are known in principle from the state of the art. For example, such systems are used as respective holders for the passage of electric conductors within a control cabinet. Due to the comparatively high amperages that can occur in the conductors, considerable electromagnetic forces develop between conductors of different polarity, between different phases or also between a phase and a neutral conductor, which forces have to be absorbed by the said holder. This, therefore, consists of a plastics whose electrical insulating properties have to be brought into line with the mechanical requirements. This means as a general rule that the insulating properties of such a holder are worse than they could be with a holder which is slightly loaded mechanically or not at all.

### SUMMARY

An aspect of the invention provides a modular system for holding a plurality of electric conductors, the system comprising: an electrically insulating holder including a plurality of through-holes spaced at a distance from one another for allowing passage of the electric conductors; a base plate including a material with better insulating properties than the electrically insulating holder; and a first connecting element configured to connect the holder to the base plate.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 an exemplary modular system in an oblique view fastened on a carrier profile;

FIG. 2 an exemplary modular system in an exploded view;

FIG. 3 an exemplary modular system in side view; and

FIG. 4 a cross section through a holder of the modular system.

### DETAILED DESCRIPTION

An aspect of the invention provides a modular system for holding a number of electric conductors, comprising an electrically insulating holder with a number of through-holes spaced at a distance from one another for allowing the passage of said electric conductors.

It is an aspect of the invention to provide an improved modular system for holding a number of electric conductors. In particular, the creeping current behavior is improved.

An aspect of the invention provides a modular system comprising a base plate consisting of a material having better insulating properties than the holder, and comprising first means for connecting the holder to the base plate.

The mechanical requirements, that is, the absorption of forces between the electric conductors is substantially fulfilled in the suggested system by the actual holder, whereas the insulation towards a base surface, to which the modular system can be fastened, is achieved by a base plate. Due to the fact that this is hardly loaded mechanically, the material for the base plate can be selected almost exclusively with regard to the electrical insulation properties. The creeping current resistance can thereby be improved with the same dimensions of the holding system compared to the state of the art, or the system can be reduced with the same creeping current resistance with regard to the state of the art. The electric conductors can for example be bus bars (“bus bars”).

As a material for the holder and the base plate, plastics, ceramics and/or glass are possible. In particular, it is also conceivable to manufacture the holder and the base plate of different types of material. For example, the holder can consist of plastics (in particular of fiber-reinforced plastics), whereas the base plate is manufactured of ceramics or glass. Glass and ceramics have excellent insulating properties, whereas plastics, in addition to its insulating properties, also has advantageous mechanical properties. Different types of plastics can naturally also be used for the holder and the base plate.

Further advantageous designs and further developments of the invention result from the dependent claims and from the description in connection with the figures.

It is advantageous if the modular system comprises a cover plate extending over a number of holders and a) second means for connecting the holder to the cover plate are formed, or when b) the first connecting means are formed for connecting the holder, base plate and cover plate. In this manner, a number of holders, respective base plates can be lined up and assembled to a coherent compound with the aid of the cover late. It is thereby favorable if conductors are passed within a holder, between which conductors relatively high forces occur, so that these can be received within a holder.

It is particularly advantageous if the cover plate and/or the first and/or the second connecting means are manufactured of an insulator. In this manner, the formation of a current loop around the electric conductors is avoided when the modular system is fastened to a metallic base surface. Undesired induced circular currents can thus be avoided. As with the holder and the base plate, for example plastics, ceramics or glass are possible as material for the cover plate and/or the first and/or the second connecting means. The cover plate and the connecting means can again be manufactured of different materials. For example, the cover plate can consist of ceramics or glass, whereas the connecting means are manufactured of plastics (in particular of fiber-reinforced plastics).

It is favorable if the first and/or the second connecting means are formed as screws. Thereby, the modular system can be assembled to a self-contained but releasable compound with easily available and tested means.

It is favorable if the holder, the base plate and optionally the cover plate have congruent through-holes. In this manner, the modular system can simultaneously be assembled into a cohesive compound and can also be fastened on a base surface. For example, screws can be passed through the through-holes.

It is favorable if the through-holes for the electric conductors taper in their longitudinal direction from both sides toward the center. In other words, the cross section of the through-holes reduces in their longitudinal direction from both sides toward the center. In this manner, a movement, that is, a rotation about a rotational axis transversely to the hole axis, of electric conductors is enabled in the through-holes, without resulting in a point- or line-shaped load on the outer edges of the through-holes. The occurring forces are thus discharged in a better manner within the holder in this way. For example, the said movement of the electric conductors can be caused by electromagnetic forces or also when the electric conductors are already cambered therein during the installation of the holder.

At this point it is noted that the mentioned measures can also form the basis of an independent invention, regardless of the measures described above. A holder for a number of electric conductors of an electrically insulating material with a number of through-holes spaced at a distance from one another for allowing the passage of said electric conductors results in this manner, wherein the through-holes for the electric conductors taper in their longitudinal direction from both sides toward the center.

It is favorable if the through-holes have a straight tapering section in the central region. In the case of a circular hole cross section, a section of two (truncated) cones thus results in the center, in the case of a square hole cross-section, a section of two pyramid (stumps).

It is however also favorable if the through-holes are cambered in the longitudinal direction on at least 60% of their length, as a good mobility of the electrical conductor in the through-hole or the power transmission between the two is then enabled.

It is particularly advantageous if the through-holes are cambered the longitudinal direction over their entire length. The mobility of the electric conductor in the through-hole or the power transmission between the two is thereby further improved.

It is furthermore favorable if the through-holes have a rectangular cross section. The juxtaposition of conductors can thereby take place in a particularly compact manner.

It is furthermore advantageous if the holder comprises integrated means for connecting a further holder above, below or adjacent to the first-mentioned holder. These can for example be formed as connecting ribs or integral expanding rivets. In such a way, the stacking, respectively the juxtaposition of a number of holders is facilitated.

At this point it is noted that the mentioned measures can also form the basis of an independent invention, regardless of the measures described above. A holder for a number of electric conductors of an electrically insulating material with a number of through-holes spaced at a distance from one another for allowing the passage of said electric conductors results in this manner, wherein the holder comprises integrated means for connecting a further holder above, below or adjacent to the first-mentioned holder.

It is also particularly advantageous if the holder is undivided and a number of conductors of different polarity are passed through the holder of the modular system. In this manner, forces between the electric conductors (for example, electromagnetically induced forces) are discharged within the holder. Components adjoining the holder are however not loaded or only slightly loaded, whereby these can be designed more freely.

At this point it is noted that the mentioned measures can also form the basis of an independent invention, regardless of the measures described above. An arrangement results in this manner, comprising a holder of an electrically insulating material with a number of through-holes spaced at a distance and a number of electric conductors passed through the through-holes, wherein the holder is undivided and a number of conductors of different polarity are passed through the holder.

Finally, it is also advantageous if a modular system, respectively a holder and a number of electric conductors passed through the through-holes are installed in a control cabinet, as the aforementioned advantages come to light here in particular.

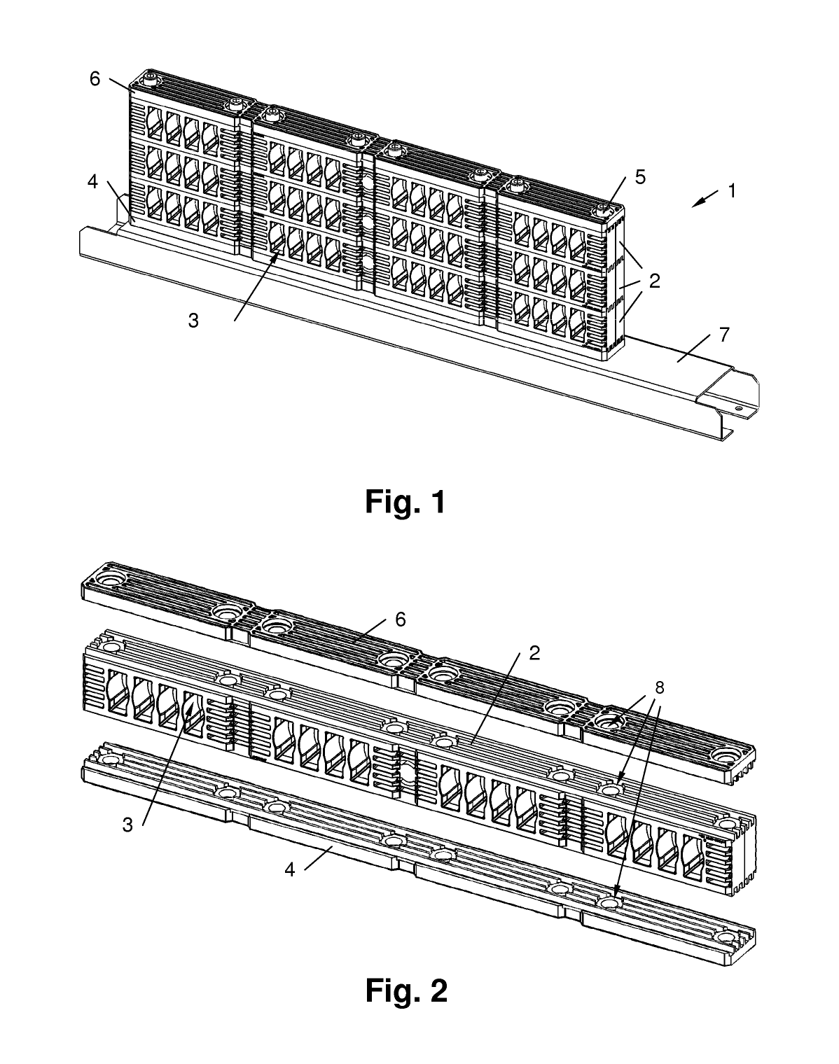

FIG. 1 shows a first example of a modular system 1 for holding a number of electric conductors. The system 1 comprises three electrically insulating holders 2 with respectively a number of through-holes 3 spaced at a distance from one another for allowing the passage of said electric conductors. In addition, the system comprises a base plate 4 consisting of a material with better insulating properties than the holder 2 and first means 5 for connecting the holders 2 to the base plate 4, which are formed as screws in this case. It would however also be conceivable, for example, that the connection means 5 are formed as rivets, especially expanding rivets. These expanding rivets can be formed directly to the holder 2, respectively to the base plate 4.

The modular system 1 further comprises an optional cover plate 6 in this example. In this case, the holders 2 are exclusively stacked on top of one another. It would however also be conceivable that these are arranged laterally adjacent to each other. In this case, the cover plate 6 can extend over a number of holders 2, that is, the cover plate 6 can be longer than a holder 2. The same also applies to the base plate 4.

In the arrangement illustrated in FIG. 1, the screws 5 are formed for connecting the holders 2, the base plate 4 and the cover plate 6. Specifically, the holders 2, the base plate 4 and cover plate 6 have congruent through-holes 8 (also see FIG. 2), through which the screws 5 can be inserted and with the aid of which the modular system 1 can not only be assembled to a solid compound, but also be mounted onto an assembly surface. In FIG. 1, the assembly surface is formed by the top of a support profile 7, which can for example be part of a control cabinet.

The through-holes 8 are however not at all mandatory for the modular system 1. It would also be conceivable that, in addition to the first connecting means for connecting the holder 2 to the base plate 4, second connecting means for connecting the holder 2 to the cover plate 6 are provided in addition. These can also be formed as expanding rivets, which are advantageously formed directly onto the holder 2, respectively onto the cover plate 6.

The cover plate 6 and/or the connecting means 5 are preferably manufactured of an insulator. In this manner, the formation of a current loop around the electric conductor is avoided when the modular system 1 is fastened on a metallic base surface, that is, when the support profile 7 of FIG. 1 consists of metal. Undesired induced currents can thus be avoided.

Such as the holders 2 and the base plate 4, the cover plate 6 and/or the connecting means 5 can be manufactured of an electrically insulating plastic. The use of other insulating materials, such as ceramics or glass would also be conceivable. The holders 2, the base plate 4, the cover plate 6 and the connecting means 5 can also be manufactured of different materials. For example, the holders 2 and the connecting means 5 can consist of plastics, whereas the base plate 4 and the cover plate 6 are manufactured of glass or ceramics. The holders 2, the base plate 4, the cover plate 6 and the connecting means 5 can however be manufactured of different plastics.

Thermoplastics, thermosets or elastomers can generally be used as plastics. For example, polyethylene (PE), polypropylene (PP), polyvinyl chloride (PVC), polystyrene (PS), polyurethane (PU), polyethylene terephthalate (PET), polycarbonate (PC), polyamide (PA) or silicone can be used. In particular, the use of fiber-reinforced plastics (or also fiber-reinforced ceramics) is also conceivable in order to improve the mechanical properties. This is especially advantageous for the comparatively highly mechanically loaded holders 2.

FIG. 2 shows a modular system 1 for clarification again in an exploded view (however without screws 5). The congruent through-holes 8 can be seen well.

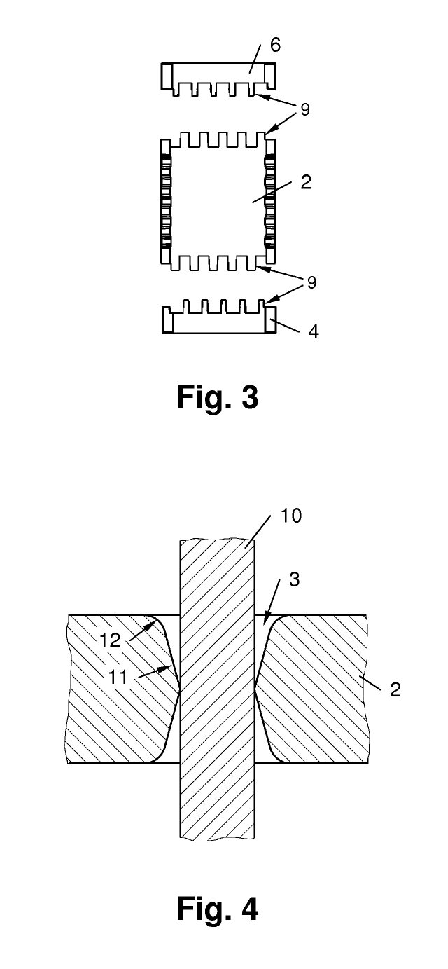

FIG. 3 now shows an exemplary modular system 1 in a side view. The ribs 9 offset to each other can be seen well, which can function as a connecting means between holders 2 to a base plate 4 or a cover plate 6. The ribs 9 can for example be combined with integral expanding rivets or they can form a snap connection or a dovetail joint themselves, so that the individual parts 2, 4, 6 of the modular system 1 only have to be plugged together or pressed together.

In FIG. 3, the ribs 9 are formed for stacking the individual parts 2, 4, 6 of the modular system 1. Correspondingly, these can alternatively or additionally also be arranged laterally to allow the juxtaposition of the holders 2, the base plates 4 and the cover plates 6. The ribs 9 can also form a snap connection or a dovetail joint form here or can be combined with expanding rivets.

FIG. 4 now shows a detail of a cross section through a holder 2, specifically a through-hole 3, through which an electric conductor 10 is inserted. In this embodiment, a through-hole 3 tapers in its longitudinal direction from both sides toward the center. In other words, the (for example rectangular) cross section of the through-hole 3 becomes smaller in its longitudinal direction from both sides toward the center. In this manner, a movement of the electric conductor 10 in the through-hole 3 is made possible, without leading to a point- or line-shaped load at the outer edges of the through-hole 3. The forces occurring can thus be discharged within the holder 2 in a better manner. For example, the said movement of the electric conductor 10 can be caused by an electromagnetic force acting on it. It would also be conceivable, for example, that this is already built into the holder 2 in a tilted manner.

Specifically, the through-hole 3 illustrated in FIG. 4 has straight tapering sections 11 in the central region, whereas the outer edges of the through-hole 3 are delimited by curvatures 12. But it would also be conceivable that a through-hole is 3 is cambered in a wider region, that is, has a curved surface. Advantageously, the through-hole 3 is cambered to at least 60% of its the length, better still, generally all along its entire length.

It is generally advantageous if the holder 2 is undivided and a number of conductors 10 with different polarity are passed through the holder 2 of the modular system 1. In this manner, forces between the electric conductors 10 (for example, electromagnetically induced forces) are discharged within the holder 2. Components 4, 6 abutting the holder are however not or only slightly loaded mechanically, resulting in more extensive design options for the same.

In FIGS. 1 to 2, holders 2 have respectively been illustrated, which each have four groups with four through-holes 3 each. This is of course not a mandatory condition for the invention. Of course, more or less through-holes 3 can be provided and can also be arranged grouped differently or ungrouped. Furthermore, it is also conceivable that the holder 2 can be shortened, for example between two groups with four through-holes 3 each. It is also conceivable that shorter holders 2 can be manufactured by inserting a special molded part into an injection mold for the holder 2.

Finally, it is noted that the arrangements illustrated in FIGS. 1 to 4 are not necessarily shown to scale and thus can also have other proportions. Furthermore, the arrangements can also comprise more or fewer components than illustrated. Position information (e.g. “up”, “down”, “left”, “right”, etc.) are related to the figure respectively described and must be adapted correspondingly to the new position with a change of position. Finally, it is noted that the above designs and further developments of the invention can be combined in an arbitrary manner.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A modular system for holding a plurality of electric conductors, the system comprising:
an electrically insulating holder including a plurality of through-holes spaced at a distance from one another for allowing passage of the electric conductors;
a base plate including a material with better insulating properties than the electrically insulating holder; and
a first connecting element configured to connect the holder to the base plate.

2. The system of claim 1, further comprising:
a cover plate extending over a plurality of electrically insulating holders; and
(a) a second connecting element configured to connect the holder to the cover plate.

3. The system of claim 2, wherein the cover plate and/or the first and/or the second connecting elements are manufactured from a material including an insulator.

4. The system of claim 1, wherein the holder and the base plate have congruent through-holes.

5. The system of claim 1, wherein the through-holes taper in their longitudinal direction from both sides towards their center.

6. The system claim 5, wherein the through-holes include a straight tapering section in central region.

7. The system claim 5, wherein the through-holes are cambered in a longitudinal direction to at least 60% of their length.

8. The system of claim 1, wherein the electrically insulating holder includes an integrated connecting device configured to connect a further holder above, below, or adjacent to the electrically insulating holder.

9. An arrangement, comprising:
the modular system of claim 1; and
a plurality of the electric conductors passed through the through-holes,
wherein the electrically insulating holder is undivided, and
wherein one or more of plurality of electric conductors have different polarity.

10. A control cabinet, comprising;
the modular system of claim 1; and
a plurality of the electric conductors passed through the through-holes.

11. The system of claim 1, further comprising:
a cover plate extending over a plurality of electrically insulating holders; and
(a) a second element configured to connect the holder to the cover plate.

12. The system of claim 1, further comprising:
a cover plate extending over a plurality of electrically insulating holders; and
(b) wherein the first element is configured to connect the holder, the base plate, and the cover plate.

13. The system of claim 2, wherein the holder, the base plate, and the cover plate include congruent through-holes.

14. The system of claim 1, wherein the first connecting element is configured to connect the holder, the base plate, and the cover plate.
